(19) United States
(12) Patent Application Publication
(10) Pub. No.: US 2015/0365864 A1
(43) Pub. Date: Dec. 17, 2015

(54) Allowing Access to WIFI Network Based on Network Properties

(71) Applicant: Telefonaktiebolaget L M Ericsson (publ), Stockholm (SE)

(72) Inventors: Per-Daniel STALNACKE, BROMMA (SE); Tomas NYLANDER, VÄRMDÖ (SE)

(21) Appl. No.: 14/761,836

(22) PCT Filed: Feb. 15, 2013
(86) PCT No.: PCT/EP2013/053060

§ 371 Date: Jul. 17, 2015

(51) Int. Cl. H04W 36/14; H04W 48/18

(52) U.S. Cl. CPC H04W 36/14; H04W 48/18

(57) ABSTRACT

A method and node for determining whether to allow access of a mobile terminal to a WiFi access network cell is provided. The node determines a property of the WiFi access network and determines a corresponding property of a further radio access network, such as a 3GPP radio access network. On the basis of the WiFi property and the corresponding further radio access network property, the node determines whether to allow access of the mobile terminal to the WiFi access network cell. This ensures that the mobile terminal can connect to an access network that is best able to serve it. In one embodiment the node is located in the further radio access network and thus receives the WiFi property from the WiFi access network cell to make a decision. The node may be an eNodeB, a RNC or a home base station. In another embodiment the node is located in the WiFi access network and thus receives the further radio access network property from the further radio access network to make a decision. The node may be a WiFi access point or a WiFi access controller.

### TECHNICAL FIELD

The invention relates to the field of allowing access of a mobile terminal to a WiFi network.

### BACKGROUND

There is currently a drive to use WiFi access networks to off-load the 3GPP network. As illustrated in FIG. 1, node such as a Radio Base Station (RBS) 1 provides 3GPP services within a certain area A. Within that area A, one of more WiFi ‘hotspots’ may be provided by WiFi Access Points (APs) 2, each of which allows WiFi access to a communications network for a mobile terminal 3 such as a User Equipment (UE). A UE 3 therefore can choose to access a communications network via 3GPP, WiFi or both.

UEs 3 that are both 3GPP capable and WiFi capable can use either type of access. If a UE 3 is capable of accessing a WiFi Access Point, and such accessing is enabled, the UE 3 will typically automatically connect to a (known) WiFi network as soon as the UE 3 detects the WiFi network. The UE 3 will maintain its 3GPP registration for services such as voice and short message service (SMS), but will normally use the WiFi access network for packet data.

The decision for the UE 3 to move from the 3GPP Radio Access Technology (RAT) to the WiFi access network is taken by the UE without any knowledge about the situation in the 3GPP access network or the WiFi access network. This can lead to a potentially worse performance and an overload at the WiFi access network even when the 3GPP access network has spare capacity.

Neither the 3GPP access network nor the WiFi access network has any knowledge about the other. When the UE 3 connects to the WiFi access network, it appears to the 3GPP access network that the UE 3 is simply disconnecting from the 3GPP access network just like any other disconnection, while in fact it has moved to the WiFi access network.

Currently, the UE 3 automatically moves to an available WiFi access network. This may cause inefficient utilisation of network resources, especially where the WiFi access network is already heavily loaded and the 3GPP access network is under-utilised.

### SUMMARY

It is an object of the invention to provide a mechanism by which a mobile terminal such as a UE can remain with an existing access network such as a 3GPP network or move to a WiFi access network, depending on which network would better serve the mobile terminal.

According to a first aspect, there is provided a method of determining whether to allow access of a mobile terminal to a WiFi access network cell. A node determines a property of the WiFi access network and determines a corresponding property of a further radio access network. On the basis of the WiFi property and the corresponding further radio access network property, the node determines whether to allow access of the mobile terminal to the WiFi access network cell. This ensures that the mobile terminal can connect to an access network that is best able to serve it.

In an optional embodiment, the property and the corresponding property are both selected from any of a signal strength, an air interface load, a network load, network capabilities, network congestion, available bandwidth, estimated bandwidth, and conditions of a corresponding backhaul network.

These properties allow conditions of the network to be determined in order to assist in selecting the best access network.

As an option, the further radio access network is a 3GPP radio access network.

As an option, the node is located in the further radio access network. In the case, the method optionally comprises receiving from a node in the WiFi network cell a message, the message including the WiFi property and an identifier of the mobile terminal. The node then sends a message to the mobile terminal, and subsequently receives a response from the mobile terminal, the response indicating the corresponding property of the further radio access network. After determining whether to allow access of the mobile terminal to the WiFi access network cell, the nodes sends a message to the node in the WiFi network a message that includes the results of the determination.

As a further option, the node in the further radio access network is selected from any of an eNodeB, a Radio Network Controller and a Home Base Station.

As an alternative option, the node is located in the WiFi access network cell. As a further option, the method comprises sending to a node in the further radio access network cell a request message requesting a value for the corresponding property of the further radio access network and an identifier of the mobile terminal. The node then receives, from the node in the further radio access network cell, a response message. The response message includes a value for the corresponding property of the further radio access network.

As a further option, the node is any of a WiFi Access Point and a WiFi Access Controller.

As an option, the identifier of the mobile terminal is any of a Temporary Mobile Subscriber Identity and an International Mobile Subscriber Identity, although it will be appreciated that other types of identifier may be used.

In addition to determining the properties, the method optionally comprises additionally determining whether to allow access of the mobile terminal to the WiFi access network cell on the basis of any of congestion, available bandwidth between the mobile terminal and the further radio access network cell, available bandwidth between the mobile terminal and the WiFi access network cell, an estimated bandwidth between the mobile terminal and the further radio access network cell and an estimated bandwidth between the mobile terminal and the WiFi access network cell.

According to a second aspect, there is provided a node for determining whether to allow access of a mobile terminal to a WiFi access network cell. The node is provided with a processor arranged to determine a property of the WiFi access network. The processor is further arranged to determine a corresponding property of a further radio access network. The processor is further arranged to, on the basis of the WiFi property and the further radio access network property, determine whether to allow access of the mobile terminal to the WiFi access network cell.

The property and the corresponding property are optionally selected from any of a signal strength, an air interface load, a network load, network capabilities, network congestion, available bandwidth, estimated bandwidth, and conditions of a corresponding backhaul network.

The node is optionally located in the further radio access network cell. As a further option, the node is provided with a first receiver for receiving from a node in the WiFi network cell a message, the message including the WiFi property and an identifier of the mobile terminal. A first transmitter is provided for sending to the mobile terminal a message. A second receiver is provided for receiving from the mobile terminal a response, the response indicating the further radio access network corresponding property. A second transmitter is provided for, after determining whether to allow access of the mobile terminal to the WiFi access network cell, sending to the node in the WiFi network cell a message including the results of the determination. Optional examples of such a node are an eNodeB, a Radio Network Controller, and a Home Base Station.

As an alternative option, the node is located in the WiFi access network cell. As a further option, the node is provided with a transmitter for sending to a node in the further radio access network cell a request message requesting a value for the further radio access network corresponding property, the request message including an identifier of the mobile terminal. A receiver is also provided for receiving from the node in the further radio access network cell a response message, the response message including a value for the further radio access network corresponding property. Optional examples of such a node include a WiFi Access Point and a WiFi Access Controller.

According to a third aspect, there is provided a computer program comprising computer readable code which, when run on a node causes the node to perform the method as described above in the first aspect.

According to a fourth aspect, there is provided a computer program product comprising a computer readable medium and a computer program as described above in the third aspect. The computer program is stored on the computer readable medium.

According to a fifth aspect, there is provided a method as described above in the first aspect, when operated on a vessel or vehicle.

According to a sixth aspect, there is provided a vessel or vehicle comprising the node as described above in the second aspect.

### BRIEF DESCRIPTION OF DRAWINGS

FIG. 1 illustrates schematically in a block diagram an exemplary network architecture;

FIG. 2 is a flow diagram showing steps of an exemplary embodiment;

FIG. 3 is a signalling diagram showing signalling in an embodiment in which a WiFi node determines whether to allow access to a UE;

FIG. 4 is a signalling diagram showing signalling in an embodiment in which a radio access node determines whether to allow access to a UE;

FIG. 5 illustrates schematically in a block diagram an exemplary 3GPP node;

FIG. 6 illustrates schematically in a block diagram an exemplary WiFi node; and

FIG. 7 illustrates schematically in a block diagram an exemplary vessel or vehicle.

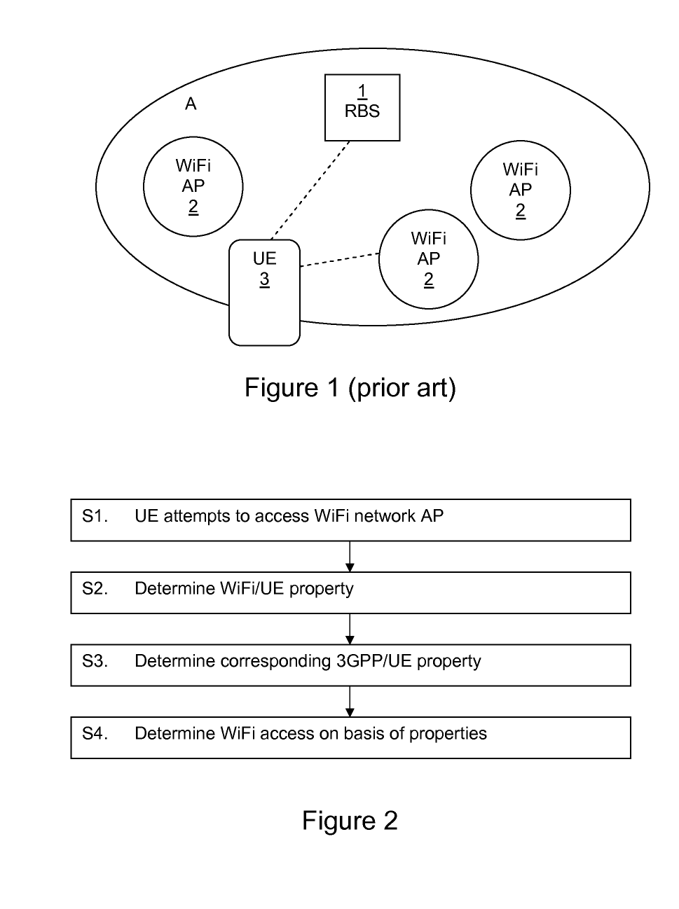

### DETAILED DESCRIPTION

The following description uses the term “WiFi access network cell”. This term is used to refer to a coverage region or area that is served by one WiFi Access Point (AP). It will be appreciated that WiFi access network cells may overlap, in which case an AP for one of the WiFi access network cells may be more suitable for use (for example, because the AP can provide a better signal strength, more bandwidth, higher capacity etc.) than another WiFi access network cell.

When a mobile terminal such as a UE 3 attempts to access a WiFi access network cell, the signal strength between the UE 3 and the WiFi access network AP is determined, and the signal strength between the UE 3 and a further radio access network cell (typically a 3GPP network) is determined. On the basis of these signal strengths, a determination is made whether to allow the UE to connect to the AP serving the WiFi access network cell or to maintain its connection with the further radio access network cell. This ensures that the access network that can provide the best service to the UE 3 is selected. The description below assumes that the further radio access network cell is a 3GPP radio access network cell, and that the mobile terminal is a UE 3. It will be appreciated that the mobile terminal may be any kind of terminal or client device that is capable of accessing the WiFi access network cell and the further radio access network cell. Furthermore, the description below assumes that the further radio access cell is a 3GPP radio access network cell. It will be appreciated that the further radio access network cell may be a different type of access network cell, such as a second WiFi access network cell.

Basic steps are illustrated in FIG. 2. The following numbering corresponds to that of FIG. 2:

S1. The UE 3 attempts to connect to a WiFi AP 2.
S2. A determination is made of a property of the WiFi access network and/or the WiFi access network cell that the UE 3 is attempting to access. In an embodiment, the determined property is signal strength between the UE 3 and the WiFi AP 2. However, it will be appreciated that many other properties may also be used to determine the most suitable access network for the terminal. Examples of such properties include network load, network capabilities, network congestion, available bandwidth, estimated bandwidth and conditions and capacity of the associated backhaul network.
S3. A determination is made of a corresponding property for the 3GPP access network.
S4. The signal strengths or other properties of the connection or network are used to determine whether or not the UE's 3 attempt to connect to the WiFi AP 2 is accepted or not.

When the UE 3 finds a WiFi AP 2 that is available, and the UE 3 attempts to associate itself with the AP 2, the AP 2 knows the signal strength on the WiFi side. A problem is in obtaining the signal strength on the 3GPP side. If the UE 3 is active on 3GPP technology and has good signal strength from its serving cell, the UE 3 will, in current normal use, not report any measurements to the 3GPP access network since measurements in 3GPP are triggered by passing signal strength thresholds. If the 3GPP signal strength is adequate then no signal strength measurements will be reported. This means that there are no signal strength measurements available on the 3GPP side to compare with the WiFi signal strength measurements.

A further problem with known access networks is that there is no mechanism for the WiFi access network to query the 3GPP access network about signal strength. Furthermore, the WiFi access network does not know the identity that the UE 3 is using in the 3GPP access network, so has no way of querying the 3GPP access network. The WiFi access network may know or obtain an identifier (that may be permanent or temporary) to identify the UE 3. An example of such an identifier is an International Mobile Subscriber Identity (IMSI) permanent identifier when the UE is authenticating with the WiFi system. The IMSI is known in the controller node for WCDMA (3G), i.e. the Radio Network Controller (RNC) or, in case of a flat 3G architecture, by the femto RBS, also known as a Home NodeB (HNB) or Home eNodeB (HeNB). However, for a Long Term Evolution (LTE) network, the controller node (the eNodeB, or eNB) only knows a temporary identifier identifying the UE, the Temporary Mobile Subscriber Identity (TMSI). In order to provide a common solution for both 3G and LTE networks, a preferred option is to use the TMSI for the 3GPP and WiFi access networks to identify the UE 3. Note, however, that other identifiers could be used, such as an eNB S1AP identifier, an MME S1AP identifier or a Radio Network Temporary Identifier (RNTI).

A UE 3 that is registered and active with a 3GPP network should, when associating with a WiFi AP 2, provide a temporary 3GPP identity (for example the TMSI). The WiFi AP can then, for the active UE 3, use the TMSI when communicating with the 3GPP system to identify the UE 3. The TMSI can therefore be used to, for example, send a query from the WiFi AP 2 to a node 4 in the 3GPP network that makes a query about the UE 3 signal strength and quality on the 3GPP side.

The 3GPP network can obtain a measurement from the UE 3 at reception of the query (if requested information is not known) about the signal strength between the UE 3 and the 3GPP network or alternatively, if a background measurement report is available, use that.

In one embodiment, the WiFi network makes the decision as to whether to admit the UE 3 to the WiFi access network cell, in an alternative embodiment, the decision is made in the 3GPP network and reported to a node in the WiFi access network cell. These two embodiments are described in more detail below.

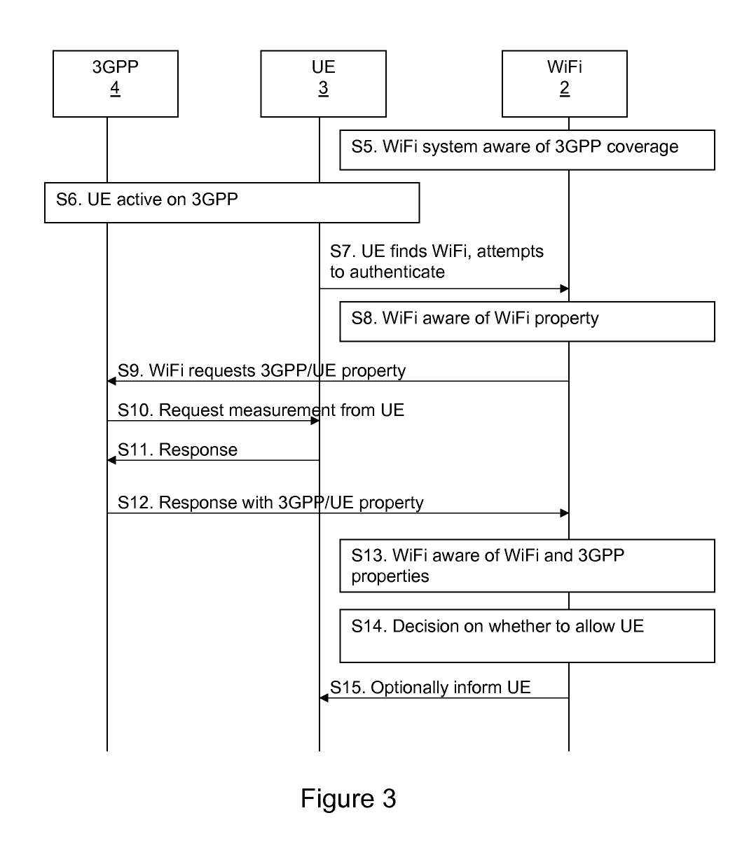

FIG. 3 is a signalling diagram illustrating exemplary signalling where the decision on whether to allow the UE 3 to connect to the WiFi AP2 is made at a node in the WiFi access network cell. The following numbering corresponds to that of FIG. 3:

S5. A node such as an AP or a WiFi Access Controller in the WiFi access network cell is aware of overlapping 3GPP coverage, and the systems and systems and cells of the overlapping 3GPP coverage. How the WiFi access network cell node becomes aware of overlapping 3GPP coverage is outside the scope of this description. However, the WiFi access network cell must be able to determine the identities of controller nodes in the 3GPP system. In an embodiment, that information may be configured in the WiFi APs 2, and the UE 3 can use that information to connect and authenticate to a certain Core Network, for example using the HotSpot 2. specification. With the 802.11u and the new HotSpot 2.0 specifications it is possible for the UE to query the WiFi AP about, among other things, which 3GPP PLMNs that can be accessed via the AP. That information is configured in the WiFi APs the UE can use that information to connect and authenticate to a certain Core Network, this is not fundamental to the invention, but could be used to optimize a solution as described later.
S6. The UE 3 is active using 3GPP RAT. In other words, there is an active Radio Resource Control (RRC) connection between the UE 3 and the 3GPP network.
S7. The UE 3 finds a WiFi AP 2 that it is allowed to use and attempts to perform an association with the AP 2. The UE 3 provides an identity such as its TMSI that can be subsequently used to identify the UE 3 in the 3GPP network in the case where the IMSI is not available or should not be used. Note that if the UE 3 is not known to the WIFI AP 2 it will also attempt to perform Authentication.
S8. The WiFi AP 2 obtains the Received signal strength indication (RSSI) on the connection in order to obtain the signal strength between the UE 3 and the WiFi AP2. As mentioned above, the signal strength is not the only parameter that may be used. Other properties may be used to determine the most suitable access network for the UE 3. Examples of such properties include network load, network capabilities, network congestion, available bandwidth, estimated bandwidth, and conditions and capacity of the associated backhaul network.
S9. Since the WiFi AP 2 is aware of the overlapping 3GPP coverage, and the 3GPP controller nodes, the WiFi AP sends a query to the controller node 4 in the 3GPP network that identifies the UE 3 and requests information about the corresponding property for the UE in the 3GPP network. As described above, the UE 3 may be identified using an IMSI or temporary identifier, for example a TMSI to allow the 3GPP controller node 4 to find the correct UE. Note that the WiFi AP 2 may overlap several cells/access technologies, and so several queries may be necessary in order to find the 3GPP controller node 4 serving the UE 3. However, a controller node 4 is likely to control several cells of the same technology so not more than one query per access technology should normally be required. Note that the information provided in step S7 could also include information about which 3GPP technology the UE 3 is using. Alternatively, the TMSI can be used to determine the used 3GPP technology if the WiFi network is aware of the TMSI ranges used for different access technologies.
S10. The 3GPP system (typically the 3GPP controller node 4) sends a request for a property (such as signal strength) measurement to the UE 3. Alternatively, existing measurement reports may already exist that can be used, avoiding the need to trigger a measurement from the UE 3, and removing the need for step S11.
S11. The UE 3 sends property measurements back to the 3GPP controller node 4.
S12. The 3GPP controller node 4 sends a response to the WiFi system reporting the 3GPP property measurements to the WiFi AP 2.
S13. The WiFi AP 2 is now aware of the WiFi property and the corresponding 3GPP property.
S14. The WiFi AP 2 determines on the basis of the two properties whether or not to allow the UE 3 to connect to the WiFi AP 2. For example, if the WiFi property (e.g. the signal strength between the WiFi AP 2 and the UE 3) is poor and the 3GPP property (e.g. the signal strength between the 3GPP network and the UE 3) is good, then connection to the WiFi AP 2 may not be allowed. Conversely, if the WiFi property is good and the 3GPP property is poor, then connection to the WiFi AP 2 is likely to be allowed.
S15. The WiFi AP 2 may optionally implicitly inform the UE 3 of the decision. Alternatively, it will either allow connection of the UE 3 to the WiFi AP 2 (if that is the determination) or simply refuse connection to the WiFi AP 2.

It will be appreciated in the embodiment described above that decision on whether or not to allow access to the WiFi access network cell may be taken by the WiFi AP 2 or another node in the WiFi access network. It will also be appreciated that the 3GPP controller node 4 may be a node such as an eNodeB, a Home Base Station, a Home NodeB (HNB), a Home eNodeB (HeNB), an RNC and so on. Furthermore, the 3GPP controller node 4 may instruct another node in the 3GPP network to obtain the property measurements. Furthermore, while the above description refers to a 3GPP access network, it will be appreciated that the same techniques may be used with any other type of radio access network to which the mobile terminal is attached prior to attempting to access the WiFi AP 2.

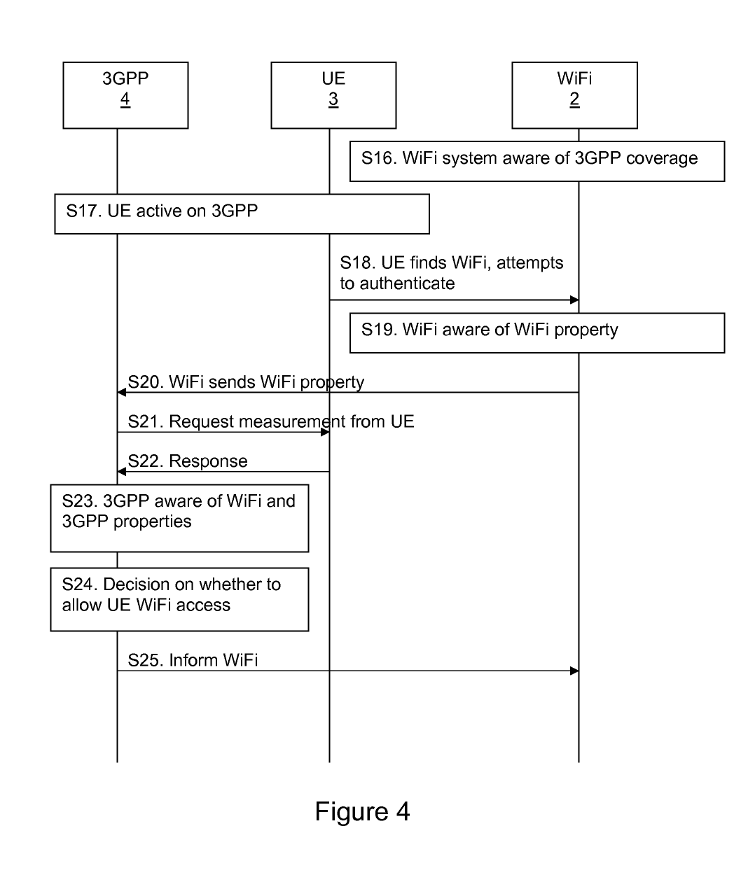

FIG. 4 is a signalling diagram showing exemplary signalling when the decision on whether to allow the UE 3 to access the WiFi AP 2 is taken on the 3GPP network side. Again, the signalling diagram refers to a 3GPP controller node 4 but it will be appreciated that the 3GPP controller node may provide instructions to other nodes to carry out some of the functions described below. The following numbering corresponds to that of FIG. 4:

S16. The WiFi access network cell is aware of overlapping 3GPP coverage, and the systems and systems and cells of the overlapping 3GPP coverage. Using the cell identities, the WiFi system can ascertain the identities of controller nodes in the 3GPP system.
S17. The UE 3 is active using 3GPP RAT. In other words, there is an RRC connection between the UE 3 and the 3GPP network.
S18. The UE 3 finds a WiFi AP 2 that it is allowed to use and attempts to perform an association with the AP 2. The UE 3 provides an identity such as its TMSI that can be subsequently used to identify the UE 3 in the 3GPP network in the case where the IMSI is not available or should not be used. Note that if the UE 3 is not known to the WIFI AP 2 it will also attempt to perform Authentication.
S19. The WiFi AP 2 obtains the RSSI on the connection in order to obtain a WiFi property such as the signal strength between the UE 3 and the WiFi AP2. As described above, the signal strength is not the only parameter that may be used. Other properties may be used to determine the most suitable access network for the UE 3. Examples of such properties include network load, network capabilities, network congestion, available bandwidth, estimated bandwidth, and conditions and capacity of the associated backhaul network.
S20. Since the WiFi AP 2 is aware of the overlapping 3GPP coverage, and the 3GPP controller nodes, the WiFi AP 2 sends a message to the 3GPP controller node 4 in the 3GPP network that identifies the UE 3 and includes the WiFi property. As described above, the UE 3 may be identified using an IMSI or TMSI to allow the 3GPP controller node 4 to find the correct UE. As described above, the WiFi AP 2 may overlap several cells/access technologies, and so several queries may be necessary in order to find the 3GPP controller node 4 serving the UE 3. However, a controller node 4 is likely to control several cells of the same technology so not more than one query per access technology should normally be required. Note that the information provided in step S7 could also include information about which 3GPP technology the UE 3 is using. Alternatively, the TMSI can be used to determine the used 3GPP technology if the WiFi network is aware of the TMSI ranges used for different access technologies.
S21. The 3GPP controller node 4 requests a corresponding property measurement from the UE 3. As an alternative, there may be an property measurement report that can be used, avoiding the need to trigger a measurement from the UE 3 and also the need for the UE to respond (step S22).
S22. The UE 3 sends a response message that includes the measured 3GPP property.
S23. The 3GPP controller node 4 is now aware of both the 3GPP property and the WiFi property.
S24. The 3GPP controller node 4 makes a determination as to whether the UE 3 can access the WiFi AP 2 or not. There are several ways that this determination can be made. For example, if the WiFi property is poor and the corresponding 3GPP property is good, then connection to the WiFi AP 2 may not be allowed. Conversely, if the WiFi property is good and the corresponding 3GPP property is poor, then connection to the WiFi AP 2 is likely to be allowed.
S25. The result of the determination is sent to the WiFi AP 2, which then allows or denies access to the UE 3 depending on the result of the determination.

Note that in the embodiments described above, further information in addition to the 3GPP property and the WiFi property may be used to make a determination as to whether the UE 3 may access the WiFi AP 2. For example, where signal strength is the property that is compared, other properties can also be used to make the determination of allowing access. For example, an indication of congestion or available bandwidth in either of the 3GPP or the WiFi networks may be used in addition to signal strength to determine whether the WiFi or 3GPP network would better server the UE 3.

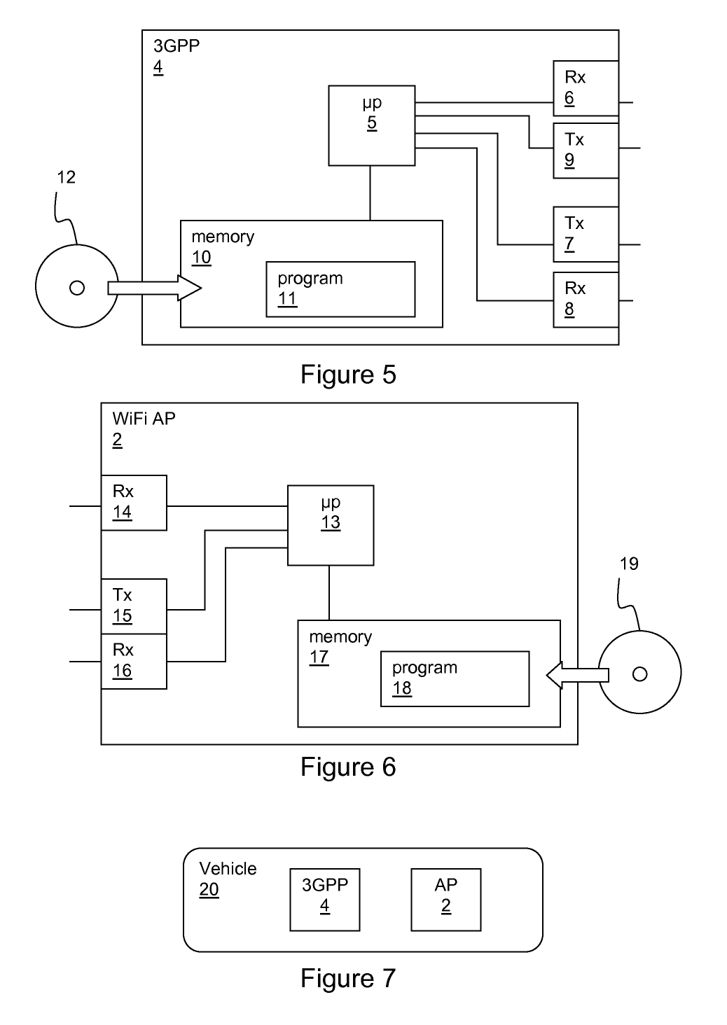

FIG. 5 illustrates schematically in a block diagram an exemplary 3GPP controller node 4 according to an embodiment. The 3GPP node 4 is provided with a processor 5 arranged to determine WiFi property and a corresponding 3GPP property. The processor 5 also, on the basis of the properties, determines whether to allow access of the UE 3 to the WiFi access network.

The 3GPP node 4 is further provided with a first receiver 6 for receiving, from a node in the WiFi network a message. The message includes the WiFi property and an identifier of the UE 3 (typically a TMSI, as described above). A first transmitter 7 is provided for sending to the UE 3 a message and a second receiver 8 is provided for receiving from the UE 3 a response that indicates the 3GPP property. A second transmitter 9 is provided for sending to the node in the WiFi network a message including the results of the determination as to whether or not the UE 3 is allowed to access the WiFi AP 2.

Examples of the 3GPP control node 4 include an eNodeB, an RNC and a Home Base Stations such as an HNB or HeNB.

The 3GPP node 4 may be further provided with a computer readable medium in the form of a memory 10 which may be used to store a computer program 11 which, when executed by the processor 5, causes the 3GPP node 4 to behave as described above. A further computer readable medium in the form of a data carrier 12, such as a compact disk or flash drive, may also be used to store the program 11. The program stored on the data carrier 12 can be transferred to the memory 10 or executed directly by the processor 5.

Turning now to FIG. 6, there is illustrated schematically a WiFi node such as a WiFi AP 2 or a WiFi Access Controller. The WiFi node 2 is provided with a processor 13 to determine the WiFi property and compare it to a corresponding 3GPP property and further to determine whether to allow access of the mobile terminal 3 to the WiFi access network. A first receiver 14 is provided for receiving a request from the mobile terminal 3 to connect to the WiFi network. A transmitter 15 is provided for sending a message querying the 3GPP property towards the 3GPP network, and a second receiver 16 is provided for receiving a response that includes the 3GPP property. The processor uses values for the WiFi property and the corresponding 3GPP property to determine whether or not to provide access to the WiFi network.

The WiFi node 2 may be further provided with a computer readable medium in the form of a memory 17 which may be used to store a computer program 18 which, when executed by the processor 13, causes the WiFi node 2 to behave as described above. A further computer readable medium in the form of a data carrier 19, such as a compact disk or flash drive, may also be used to store the program 18. The program stored on the data carrier 19 can be transferred to the memory 17 or executed directly by the processor 13.

Note that for both the 3GPP node 4 and the WiFi node 2, a database of rules (not shown) may also be provided. The database may be accessed remotely or stored in the memory 10; 17. The database of rules can be used by the processor to determine a rule to apply to the 3GPP property and the WiFi property to determine whether or not to allow access of the mobile terminal 3 to the WiFi network.

Referring now to FIG. 7, there is illustrated a vessel or vehicle 20. Example of vessels and vehicles include cars, trucks, trains, aircraft, ships and so on. The vessel or vehicle 20 is provided with any of a 3GPP node 4 as illustrated in FIG. 5 and a WiFi node 2 as illustrated in FIG. 6.

It will be appreciated by the person of skill in the art that various modifications may be made to the above-described embodiments without departing from the scope of the present invention. For example, he above description refers to a 3GPP network but it will be appreciated the same techniques can be used when a mobile terminal is connected to another type of radio access network and subsequently wishes to attach to a WiFi network.

The following acronyms have been used in the above description:

| | |
|---|---|
| 3GPP | 3rd Generation Partnership Project |
| AP | Access Point |
| DNS | Domain Name System |
| eNB | E-UTRAN NodeB |
| E-UTRAN | Evolved UTRAN |
| FQDN | Fully Qualified Domain Name |
| HNB | Home NodeB |
| HeNB | Home eNodeB |
| LTE | Long Term Evolution |
| RAT | Radio Access Technology |
| RBS | Radio Base Station |
| RNC | Radio Network Controller |
| RNTI | Radio Network Temporary Identifier |
| RRC | Radio Resource Control |
| RSSI | Received signal strength indication |
| SMS | short message service |
| TMSI | Temporary Mobile Subscriber Identity |
| UE | User Equipment |
| UTRAN | Universal Terrestrial Radio Access Network |
| WCDMA | Wideband Code Division Multiple Access |

1. A method of determining whether to allow access of a mobile terminal to a WiFi access network cell, the method comprising, at a node:
determining a property of the WiFi access network;
determining a corresponding property of a further radio access network; and
on the basis of the WiFi property and the corresponding further radio access network property, determining whether to allow access of the mobile terminal to the WiFi access network cell.

2. The method according to claim 1 wherein the property and the corresponding property are both selected from any of:
a signal strength;
an air interface load;
a network load;
network capabilities;
network congestion;
available bandwidth;
estimated bandwidth; and
conditions of a corresponding backhaul network.

3. The method according to claim 1, wherein the further radio access network is a 3GPP radio access network.

4. The method according to claim 1, wherein the node is located in the further radio access network.

5. The method according to claim 4, further comprising, at the node:
receiving from a node in the WiFi network cell a message, the message including the WiFi property and an identifier of the mobile terminal;
sending to the mobile terminal a message;
receiving from the mobile terminal a response, the response indicating the corresponding property of the further radio access network; and
after determining whether to allow access of the mobile terminal to the WiFi access network cell, sending to the node in the WiFi network a message including the results of the determination.

6. The method according to claim 3 wherein the node is selected from any of an eNodeB, a Radio Network Controller and a Home Base Station.

7. The method according to claim 1, wherein the node is located in the WiFi access network cell.

8. The method according to claim 7, further comprising:
sending to a node in the further radio access network cell a request message requesting a value for the corresponding property of the further radio access network and an identifier of the mobile terminal; and
receiving from the node in the further radio access network cell a response message, the response message including a value for the corresponding property of the further radio access network.

9. The method according to claim 7 wherein the node is any of a WiFi Access Point and a WiFi Access Controller.

10. The method according to claim 5, wherein the identifier of the mobile terminal is any of a Temporary Mobile Subscriber Identity and an International Mobile Subscriber Identity.

11. The method according to claim 1, further comprising determining whether to allow access of the mobile terminal to the WiFi access network cell on the basis of any of congestion, available bandwidth between the mobile terminal and the further radio access network cell, available bandwidth between the mobile terminal and the WiFi access network cell, an estimated bandwidth between the mobile terminal and the further radio access network cell and an estimated bandwidth between the mobile terminal and the WiFi access network cell.

12. A node for determining whether to allow access of a mobile terminal to a WiFi access network cell, the node comprising:
a processor arranged to determine a property of the WiFi access network;
the processor being further arranged to determine a corresponding property of a further radio access network; and
the processor being further arranged to, on the basis of the WiFi property and the further radio access network property, determine whether to allow access of the mobile terminal to the WiFi access network cell.

13. The node according to claim 12, wherein the processor is arranged to determine a property and the corresponding property selected from any of:
a signal strength;
an air interface load;
a network load;
network capabilities;
network congestion;
available bandwidth;
estimated bandwidth; and
conditions of a corresponding backhaul network.

14. The node according to claim 12, wherein the node is located in the further radio access network cell.

15. The node according to claim 12, further comprising:
a first receiver for receiving from a node in the WiFi network cell a message, the message including the WiFi property and an identifier of the mobile terminal;
a first transmitter for sending to the mobile terminal a message;
a second receiver for receiving from the mobile terminal a response, the response indicating the further radio access network corresponding property; and
a second transmitter for, after determining whether to allow access of the mobile terminal to the WiFi access network cell, sending to the node in the WiFi network cell a message including the results of the determination.

16. The node according to claim 12, wherein the node is selected from any of an eNodeB, a Radio Network Controller, and a Home Base Station.

17. The node according to claim 11 wherein the node is located in the WiFi access network cell.

18. The node according to claim 15, further comprising:
a transmitter for sending to a node in the further radio access network cell a request message requesting a value for the further radio access network corresponding property, the request message including an identifier of the mobile terminal; and
a receiver for receiving from the node in the further radio access network cell a response message, the response message including a value for the further radio access network corresponding property.

19. The node according to claim 15, wherein the node is any of a WiFi Access Point and a WiFi Access Controller.

20. A computer program, comprising computer readable code which, when run on a node causes the node to perform the method as claimed in claim 1.

21. A computer program product comprising a computer readable medium and a computer program according to claim 20, wherein the computer program is stored on the computer readable medium.

22. The method according to claim 1, when operated on a vessel or vehicle.

23. A vessel or vehicle comprising the node according to claim 12.
